(19) United States
(12) Patent Application Publication
(10) Pub. No.: US 2014/0357284 A1
(43) Pub. Date: Dec. 4, 2014

(54) METHOD OF OPTIMIZING LOCATION AND CONFIGURATION OF CELLULAR BASE STATIONS

(71) Applicants: KING ABDULAZIZ CITY FOR SCIENCE AND TECHNOLOGY, RIYADH (SA); KING FAHD UNIVERSITY OF PETROLEUM AND MINERALS, DHAHRAN (SA)

(72) Inventors: YASSER A. ALMOGHATHAWI, DHAHRAN (SA); SHOKRI Z. SELIM, DHAHRAN (SA); MANSOUR A. ALDAJANI, DHAHRAN (SA)

(73) Assignees: KING ABDULAZIZ CITY OF SCIENCE AND TECHNOLOGY, RIYADH (SA); KING FAHD UNIVERSITY OF PETROLEUM AND MINERALS, DHAHRAN (SA)

(21) Appl. No.: 13/910,094

(22) Filed: Jun. 4, 2013

(51) Int. Cl. H04W 16/18

(52) U.S. Cl. CPC H04W 16/18
USPC 455/446

(57) ABSTRACT

The method of optimizing location and configuration of cellular base stations optimizes the location and configuration for a group of cellular base stations to provide full coverage at a reduced cost, taking into account the constraints of area coverage, capacity of base station, and quality of service requirements for each user. A mathematical model is constructed using an integer program (IP). The base station locations are optimized to determine the minimum number of base stations and their locations that will satisfy all system constraints.

### BACKGROUND OF THE INVENTION

1. Field of the Invention

The present invention relates to cellular telephone networks, and particularly to a method of optimizing location and configuration of cellular base stations.

2. Description of the Related Art

The cellular concept is replacing a single large cell having a high-power transmitter by many small cells having low-power transmitters, where each transmitter is providing coverage to only a small portion of the service area. A cellular network could be defined as a radio network that consists of small land areas called cells, where each cell is served by fixed-location transceivers called base stations and can provide coverage over a wide geographic area, which enables a large number of portable transceivers called mobile stations to communicate with other transceivers anywhere in the network. These cells are often shown diagrammatically as hexagonal shapes, whereas, in reality, they have irregular boundaries due to the terrain over which they travel, such as hills, buildings and other objects that cause the signal to be attenuated and diminish differently in each direction.

Multiple frequencies are assigned to each cell within the cellular network, which have corresponding base stations. Those frequencies can be reused in other cells with the condition that the same frequencies are not reused in adjacent neighboring cells, which would cause co-channel interference. Hence, adjacent cells must use different frequencies, unless the two cells are sufficiently far enough from each other. Thus, the increased capacity in a cellular network results from the fact that the same radio frequency can be reused in a different area with a completely different transmission. On the other hand, if there is a single plain transmitter, only one transmission can be used on any given frequency. As the demand increases, the number of base stations may be increased. Thus, additional radio capacity is provided with no additional increase in radio to increase network capacity, and even more to cope with the explosive growth of spectrum. Hence, with a fixed number of channels, an arbitrarily large number of users can be served by reusing the channels throughout the coverage area. There are several techniques mobile phone users. Cell splitting is one technique that is used to increase network capacity without new frequency spectrum allocation. Cell splitting is reducing the size of the cell by lowering antenna height and transmitter power.

Another technique to increase network capacity is sectoring, which is dividing the cell into several sectors without changing its size using several directional antennas at the base station, instead of a single omnidirectional antenna. Using the sectoring technique will reduce radio co-channel interference. Thus, network capacity will be increased. The interference between adjacent channels in a cellular network could be minimized by assigning different frequencies to adjacent cells. Hence, cells can be grouped together to form what is called a cluster. It is necessary to limit the interference between cells having the same frequency. The larger the number of cells in the cluster, the greater the distance between cells sharing the same frequencies. By making all the cells in a cluster smaller, it is possible to increase the overall capacity of the cellular system. Hence, small, low-power base stations should be installed in areas where there are more users. Many advantages result from using the concept of cellular networks, such as increased coverage and capacity by the ability to re-use frequencies, reduced use of transmitted power, and reduced interference from other signals.

Mathematical programming is a modeling approach used for decision-making problems. Formulations of mathematical programming include a set of decision variables, which represent the decisions that need to be found, and an objective function, which is a function of the decision variables, and which assesses the quality of the solution. A mathematical program will then either minimize or maximize the value of this objective function.

The decisions of the model are subject to certain requirements and restrictions, which can be included as a set of constraints in the model. Each constraint can be described as a function of the decision variables that bounds the feasible region of the solution, and each constraint is either equal to, not less than, or not more than, a certain value. Also, another type of constraint can simply restrict the set of values that might be assigned to a variable. There remains the problem of identifying the decision variables, objective function and constraints with respect to the optimization of cellular base station locations and configuration parameters.

Thus, a method of optimizing location and configuration of cellular base stations solving the aforementioned problems is desired.

### SUMMARY OF THE INVENTION

The method of optimizing location and configuration of cellular base stations optimizes the locations and configuration for a group of cellular base stations to provide full coverage at a reduced cost, taking into account the constraints of area coverage, capacity of base station, and quality of service requirements for each user. A mathematical model is constructed using an integer program (IP). The base station locations and configuration parameters are optimized to determine the minimum number of base stations and their locations that will satisfy all system constraints.

These and other features of the present invention will become readily apparent upon further review of the following specification and drawings.

### BRIEF DESCRIPTION OF THE DRAWINGS

FIG. 1 is a plot of Demand Points and Candidate Sites used in validating the method of optimizing locations and configuration of cellular base stations according to the present invention.

FIG. 2 is a plot of optimized base station locations and configuration determined by the method of optimizing locations and configurations of cellular base stations according to the present invention.

Similar reference characters denote corresponding features consistently throughout the attached drawings.

### DETAILED DESCRIPTION OF THE PREFERRED EMBODIMENTS

At the outset, it should be understood by one of ordinary skill in the art that embodiments of the present method can comprise software or firmware code executing on a computer, a microcontroller, a microprocessor, or a DSP processor; state machines implemented in application specific or programmable logic; or numerous other forms without departing from the spirit and scope of the method described herein. The present method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

The method of optimizing location and configuration of cellular base stations optimizes the location for a group of cellular base stations to provide full coverage at a reduced cost, taking into account the constraints of area coverage, capacity of base station, and quality of service requirements for each user. A mathematical model is constructed using an integer program (IP).

The base station locations are optimized to determine the minimum number of base stations and their locations that will satisfy all system constraints. The objective of this model is to minimize the total cost of the associated base stations, taking into account the constraints of area coverage, capacity of base station, and quality of service requirements for each user. If the costs of base stations are equal, then the problem is to find the minimum number of base stations that will satisfy all constraints. We assume that the demand points and Integer Programming (IP) involve decisions that are discrete in nature. The standard IP form is described as:
Min/Max f(x)
subject to gᵢ(x)≦0
hⱼ(x)=0,
   where ƒ(x) is the objective function to be minimized or maximized; gᵢ(x) are the inequality constraints to the problem for i=1, 2, . . . , m; hⱼ(x) are the equality constraints to the problem for j=1, 2, . . . , n; and m, n are the number of the constraints for the inequalities and the equalities, respectively.

A COST-Walfisch-Ikegami (COST-WI), COST being the COopération européenne dans le domaine de la recherche Scientifique et Technique, a European Union Forum for cooperative scientific research that developed the COST portion of this model via experimental research, is a propagation model used to simulate an urban city environment. This model has many features that can be implemented easily and without an expensive geographical database, captures major properties of propagation, and is used widely in cellular network planning. The COST-WI model provides high accuracy for urban environments, where propagation over rooftops is the most dominant part, by consideration of more data to describe the character of the environment. The model considers building heights (h_{roof}), road widths (w), building separation (b), and road orientation with respect to a direct radio path (φ).

The main parameters of the model are Frequency (ƒ), which is restricted to be in the range of 800 to 2000 MHz; Height of the transmitter h_{TX}, which is restricted to be in the range of 4 to 50 meters; Height of the receiver h_{Rx}, which is restricted to be in the range of 1 to 3 meters; and Distance between transmitter and receiver (d), which is restricted to be in the range of 20 to 5000 meters. The model distinguishes between two situations, line-of-sight (LOS) and none-line-of sight (NLOS) situations. In the present method, we consider the situation of NLOS.

LOS means that there exists a direct path between the transmitter and receiver. For this case, the path loss (PL) is determined by the following expression:

PL=42.6+26·log d+20·log ƒ for d≧20 m,

where PL is the path loss in decibels, d is the distance in kilometers, and ƒ is the frequency in megahertz.

NLOS means that the path between the transmitter and receiver is partially obstructed, usually by a physical object, such as buildings, trees, hills, mountains, etc. For this case, the path loss calculation is more complicated, where the path loss is the sum of the free space loss (L₀), the rooftop-to-street diffraction loss (Lᵣₜₛ), and the multiple screen diffraction loss (L_{msd}):

$$PL = \{ \begin{matrix}{L}_{0} + {L}_{rts} + {L}_{msd} & for {L}_{rts} + {L}_{msd} > 0 \\ {L}_{0} & for {L}_{rts} + {L}_{msd} \leq 0\end{matrix} .$$

The free space loss (L₀) is determined by:

L₀=32.4+20·log d+20·log ƒ,

where L₀ is in dB, d is the distance between the transmitter and receiver in kilometers, and ƒ is the frequency in MHz. The rooftop-to-street diffraction loss (Lᵣₜₛ) determines the loss that occurs on the wave coupling into the street where the receiver is located, and it is calculated by:

Lᵣₜₛ=−16.9−10·log w+10·log ƒ+20 log(h_{roof}−h_{RX})+L_{Ori},

where w is the width of the street in meters, ƒ is the frequency in MHz, h_{roof} is the height of the base station antenna over street level in meters, h_{RX} is the mobile antenna station height in meters, and L_{Ori} is the orientation loss obtained from the calibration with measurements, and is determined by:

$${L}_{Ori} = \{ \begin{matrix}- 10 + 0.354 \cdot ϕ & for 0 ° \leq ϕ < 35 ° \\ 2.5 + 0.075 \cdot ( ϕ - 35 ° ) & for 0 ° \leq ϕ < 35 ° \\ 4.0 + 0.114 \cdot ( ϕ - 55 ° ) & for 0 ° \leq ϕ < 35 °\end{matrix}$$

The multiple screen diffraction loss is determined by:

$${L}_{msd} = {L}_{bsh} + {k}_{a} + {k}_{d} \cdot log d + {k}_{f} \cdot log f - 9 \cdot log b , \\ where \text{:}$$

$${L}_{bsh} = \{ \begin{matrix}- 18 \cdot log ( 1 + ( {h}_{TX} - {h}_{roof} ) ) & for {h}_{TX} > {h}_{roof} \\ 0 & for {h}_{TX} \leq {h}_{roof}\end{matrix} \\ {k}_{a} = \{ \begin{matrix}54 & for {h}_{TX} > {h}_{roof} \\ 54 - 0.8 \cdot ( {h}_{TX} - {h}_{roof} ) & for d \geq 0.5 km and {h}_{TX} \leq {h}_{roof} \\ 54 - 0.8 \cdot ( {h}_{TX} - {h}_{roof} ) \cdot ( \frac{d}{0.5} ) & for d < 0.5 km and {h}_{TX} \leq {h}_{roof}\end{matrix} \\ {k}_{d} = \{ \begin{matrix}18 & for {h}_{TX} > {h}_{roof} \\ 18 - 15 \cdot ( \frac{{h}_{TX} - {h}_{roof}}{{h}_{roof} - {h}_{RX}} ) & for {h}_{TX} \leq {h}_{roof}\end{matrix} and \\ {k}_{f} = - 4 + \{ \begin{matrix}0.7 \cdot ( \frac{f}{925} - 1 ) & \begin{matrix}for medium sized city and \\ suburban centers\end{matrix} \\ □ & for metropolitan centers\end{matrix} ,$$

and where h_{TX} is the height of the base station antenna above the roof top in meters, h_{roof} is the height of the roof above street level in meters, h_{RX} is the height of the mobile station antenna in meters, b is the separation between buildings in meters, and d and ƒ are as defined above.

The factor kₐ represents the increase of the path loss for base station antennas below the rooftop of the adjacent buildings. The factors and k_{d} and k_{ƒ} control the dependence of L_{msd} versus the distance and radio frequency, respectively.

In order to formulate the base station location and configuration problem, the i^{th} demand point is denoted by DPᵢ, i=1, 2, . . . , n, and the j^{th} candidate site by CSⱼ, j=1, 2, . . . , m. Each demand point represents a cluster of uniformly distributed multiple users. The set of all candidate sites is denoted by S. A base station at candidate site j can serve demand point i if the power received at DPᵢ exceeds its minimum power requirements, γ. We define S(i) as the set of candidate sites that can serve demand point DPᵢ, i.e., S(i)={j|jεS, so that the power received at DPᵢ≧}.

In this model, we solve the problems of base stations location and configuration, where the configuration of antennas in each base station involves azimuth, tilt, height, and transmitted power. The objective of this model is to minimize the total cost of the network, taking into account the constraints of area coverage, capacity of base station, and quality of service requirements for each user.

We assume that the demand points and candidate sites are known. Denote the i^{th} demand point by DPᵢ, i=1, 2, . . . , n and the jth candidate site by CSⱼ, j=1, 2, . . . , m. We will assume that a mast carries l directional antennas, where l=1, 2, . . . , N, and N is either three with 120° for each sector, or six with 60° for each sector. We consider N=3, i.e., each base station has at most 3 directional antennas. An antenna has an azimuth angle, A, where 0≦A≦359° and a tilt angle, Tε[−15°, 0]. Let P denote the power of an antenna, Pₘᵢₙ≦P≦Pₘₐₓ, and H denotes the height of an antenna, Hₘᵢₙ≦H≦Hₘₐₓ. Let (i) be the set of candidate sites that can serve test point TPᵢ by one of its antennas at a given azimuth and tilt angle, i.e.,

$$S ( i ) = \{ \begin{matrix}( jLATHP ) \vert j ∈ S ( i ) , l = 1 , 2 , 3 , 0 \leq A \leq 359 , - 15 \leq T \leq 0 , \\ {H}_{min} \leq H \leq {H}_{max} , {P}_{min} \leq P \leq {P}_{max} , \\ such that the power received at {DP}_{i} \geq γ\end{matrix} \}$$

where S is the set of candidate sites and γ is a threshold of minimum power.

The Integer Programming model for the base stations location and configuration problems is described as follows. The decision variables are: Yⱼ, X_{jlATHP}, W_{jlATHP}, and Z_{jA}. The decision variable, Y, j=1, 2, . . . , m, is defined as follows:

$${Y}_{j} = \{ \begin{matrix}1 & if a BS is constructed at {CS}_{j} \\ 0 & otherwise\end{matrix} .$$

The decision variable, X_{ijlATHP}, where i=1, 2, . . . , n, jεS(i), l=1, 2, or 3, and 0≦A≦359°, and −15°≦T≦0°, and Hₘᵢₙ≦H≦Hₘₐₓ, and Pₘᵢₙ≦P≦Pₘₐₓ, and l is the antenna, A is the azimuth, T is the tilt, H is the height, and P is the power, is defined as follows:

$${X}_{ijlATHP} = \{ \begin{matrix}1 & \begin{matrix}if a BS at {CS}_{j} with l , A , T , H and \\ P has the strongest signal at {DP}_{i}\end{matrix} \\ 0 & otherwise\end{matrix} .$$

The decision variable, W_{jlATHP}, where jεS(i), l=1, 2, or 3, and 0≦A≦359°, and −15°≦T≦0°, and Hₘᵢₙ≦H≦Hₘₐₓ, and Pₘᵢₙ≦P≦Pₘₐₓ, is defined as follows:

$${W}_{jlATHP} = \{ \begin{matrix}1 & \begin{matrix}if at {CS}_{j} , antenna l has azimuth A , \\ tilt T , height H , and power P\end{matrix} \\ 0 & otherwise\end{matrix} .$$

Note that the difference of azimuth angles of the three antennas at any mast is 120°, Hence:

W_{j,1,A,T,H,P}=W_{j,2,mod(A+1120,360),t,H,P}=w_{j,3,mod(A+240,360),T,H,P}

The decision variable Z_{jA}, where jεS(i) and 0°≦A≦359°, is defined as follows:

$${Z}_{jA} = \{ \begin{matrix}1 & if at {CS}_{j} , a BS has azimuth A \\ 0 & otherwise\end{matrix}$$

The objective function, which is the function to be optimized, is the total cost of the network. The objective function is described as:

$$Minimize {\sum }_{j = 1}^{n} {C}_{j} {Y}_{j} + {\sum }_{j ∈ S ( i )} {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {W}_{jlATHP} CP ( P ) , \qquad ( 1 )$$

where Cⱼ is the cost of installing a base station at CSj, and CP(P) is the cost of having an antenna with power P, which might not be a linear function.

The constraints include seven constraint types that bound the feasible region of the solution. The constraints are as follows. Each antenna, if chosen, at any base station has only one value of azimuth, tilt, height, and power, so that this set of constraints is written as:

$${\sum }_{A = 0}^{359} {\sum }_{T = - 15}^{0} {\sum }_{H = {H}_{min}}^{{H}_{max}} {\sum }_{P = {P}_{min}}^{{P}_{max}} {W}_{jlATHP} \leq {Y}_{j} , \\ j = 1 , 2 , … , m . \qquad ( 2 )$$

Each base station at any location has only one azimuth, so that this condition is represented by the following two sets of constraints:

$$\begin{matrix}{W}_{jlATHP} \leq {Z}_{jA} , j ∈ S ( i ) , l = 1 , 2 , 3 \; 0 \leq A \leq 359 , \\ - 15 \leq T \leq 0 , {H}_{min} \leq H \leq {H}_{max} , and {P}_{min} \leq P \leq {P}_{max} & ( 3 ) \\ {\sum }_{A = 0}^{359} {Z}_{jA} \leq 1 , j = 1 , 2 , … , m . & ( 4 )\end{matrix}$$

Further, each demand point should be served by at least one base station, so that this set of constraints is represented by:

$${\sum }_{j ∈ S ( i )} {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {W}_{jlATHP} \geq 1 , \\ i = 1 , 2 , … , n . \qquad ( 5 )$$

Each demand point should be assigned to exactly one base station, so that this set of constraints is written as:

$${\sum }_{j ∈ S ( i )} {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {X}_{ijlATHP} = 1 , \\ i = 1 , 2 , … , n . \qquad ( 6 )$$

A candidate site CSⱼ is assigned to a demand point DPᵢ if it is selected to construct a base station that has an antenna l with azimuth A, tilt T, height H, and power P, This set of constraints is represented by:

$${W}_{jlATHP} \geq {X}_{ijlATHP} , i = 1 , 2 , … , n , j ∈ S ( i ) , l = 1 , 2 , 3 , \\ 0 \leq A \leq 359 , - 15 \leq T \leq 0 , {H}_{min} \leq H \leq {H}_{max} , and \\ {P}_{min} \leq P \leq {P}_{max} . \qquad ( 7 )$$

Each base station has a capacity of Q channels, so that the numbers of demand points assigned to each base station must not exceed its limit of channels. The resulting constraint set is:

Σᵢ₌₁ⁿΣ_{A=0}³⁵⁹Σ_{T=-15}⁰Σ_{H=H}_{ₘᵢₙ}^{H}^{ₘₐₓ}Σ_{P=P}_{ₘᵢₙ}^{P}^{ₘₐₓ}X_{ijlATHP}≦Q,jεS(i), and l=1,2,3 (8)

Finally, the quality of service constraints by which the ratio of the strongest signal received at each DPᵢ to the received noise and signals from other base stations should be greater than a minimum requirement of the signal-to-interference-plus-noise ratio, SINR, Thus the constraint set is:

$$\frac{SP ( i )}{{P}_{{N}_{i}} + TP ( i ) - SP ( i )} \geq {10}^{\frac{SINR}{10}} , i = 1 , 2 , … , n . \qquad ( 9 )$$

where: SP(i) is the strongest power received at demand point DPᵢ and is given by:

SP(i)=Σ_{jεS(i)}Σᵢ₌₁³Σ_{A=0}³⁶⁰Σ_{T=-15}⁰Σ_{H=H}_{ₘᵢₙ}^{H}^{ₘₐₓ}Σ_{P=P}_{ₘᵢₙ}^{P}^{ₘₐₓ}X_{ijlATHP}P_{ijlATHP}, (10)

where P is the received power at DPᵢ.

The sum TP(i) is the total power received at DPᵢ, which is generated by all base stations at candidate sites that can serve DPᵢ, and is given by:

TP(i)=Σ_{jεS(i)}Σᵢ₌₁³Σ_{A=0}³⁶⁰Σ_{T=-15}⁰Σ_{H=H}_{ₘᵢₙ}^{H}^{ₘₐₓ}Σ_{P=P}_{ₘᵢₙ}^{P}^{ₘₐₓ}W_{jlATHP}P_{ijlATHP}, (11)

where P is the received power at DPᵢ. The variable P_{N}_{ᵢ} is the noise power at DPᵢ. SINR is the minimum signal-to-interference-plus-noise ratio. The complete IP model solving the problem of base stations location and configuration is summarized in Table 1.

TABLE 1
Base Station location and configuration complete IP model
$Minimize {\sum }_{j = 1}^{m} {C}_{j} {Y}_{j} + {\sum }_{j ∈ S ( i )}^{ } {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {W}_{jlATHP} CP ( P )$
Subject to:
$\begin{matrix}{\sum }_{A = 0}^{359} {\sum }_{T = - 15}^{0} {\sum }_{H = {H}_{min}}^{{H}_{max}} {\sum }_{P = {P}_{mtn}}^{{P}_{max}} {W}_{jlATHP} \leq {Y}_{j} , and \\ {W}_{jlATHP} \leq {Z}_{jA} , \\ {\sum }_{A = 0}^{359} {Z}_{jA} \leq 1 , \\ {\sum }_{j ∈ S ( i )}^{ } {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {W}_{jlATHP} \geq 1 , \\ {\sum }_{j ∈ S ( i )}^{ } {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {X}_{ijATHP} = 1 , and \\ {W}_{jlATHP} \geq {X}_{ijlATHP} \\ {\sum }_{i = 1}^{n} {\sum }_{A = 0}^{359} {\sum }_{T = - 15}^{0} {\sum }_{H = {H}_{min}}^{{H}_{max}} {\sum }_{P = {P}_{min}}^{{P}_{max}} {X}_{ijATHP} \leq Q \\ \frac{SP ( i )}{{P}_{{N}_{i}} + TP ( i ) - SP ( i )} \geq {10}^{\frac{SINR}{10}}\end{matrix}$
X, Y, W, Z ∈ [0, 1]

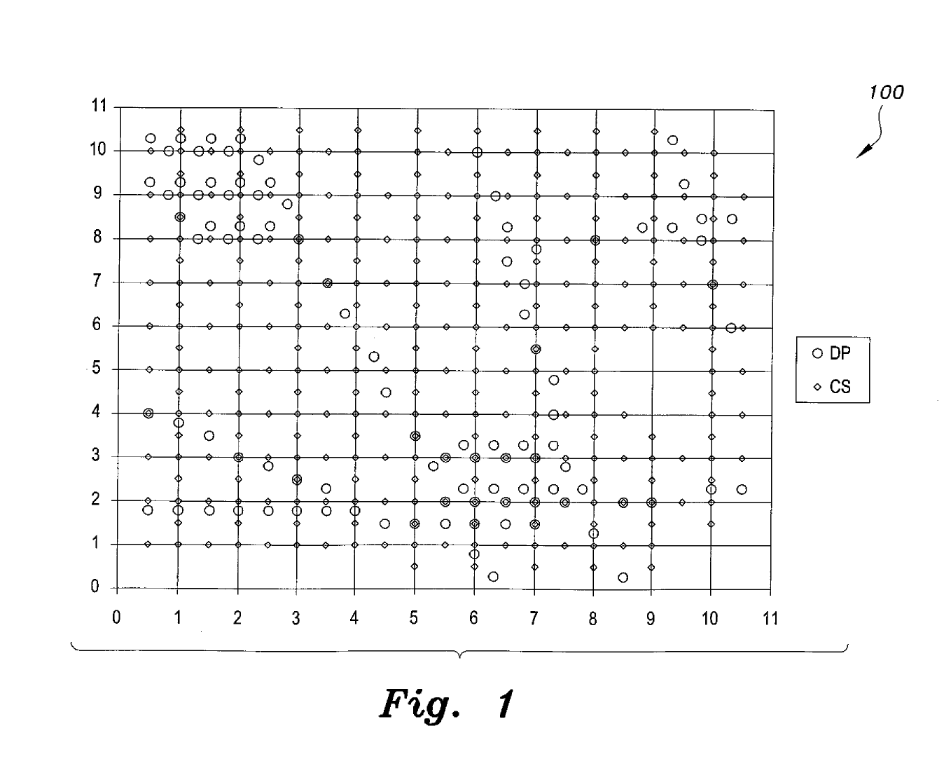

To illustrate the efficiency of the above model, a map of an area that is located on the Red Sea is discretized into an 11×11 grid. Based on our knowledge of the population distribution in the area, we assumed the demand points (DP) shown in the map, where each demand point represents a cluster of uniformly distributed multiple users. Plot 100 of FIG. 1 shows 100 demand points and the 300 selected candidate sites (CS). Parameters for the COST-WI are listed in Table 2. The other parameters used in the numerical experiments, such as transmitted power, gains, receiver sensitivity, and base station capacity, are shown in Table 3. Tilt is not considered. The noise power is assumed to be negligible.

TABLE 2
Parameters Considered for
COST-WI Propagation Model

| Parameter | Value |
|---|---|
| Frequency | 1800 MHz |
| Height of transmitter | 20 m\|25 m |
| Height of receiver | 2 m |
| Height of building | 7 m |
| Building separation | 50 m |
| Width of streets | 25 m |
| Angle | 30° |

TABLE 3
Parameters used in Numerical Experiment

| Parameter | Value 1 | | Value 2 | |
|---|---|---|---|---|
| Transmitted power | 20 | dBm | 25 | dBm |
| Transmitted antenna gain | 8 | dBi | 8 | dBi |
| Received antenna gain | 2 | dBi | 2 | dBi |
| Minimum power requirement | −95 | dBm | −95 | dBm |
| Height of Transmitter | 20 | m | 25 | m |
| Available directional antennas | 1, 2, 3 | | 1, 2, 3 | |
| Antenna azimuth | 0° | | 60° | |
| Available frequencies | 1 | | 1 | |
| Base station capacity | 30 channels | | 30 channels | |
| Antenna capacity | 10 channels | | 10 channels | |
| SINR | 20 | dB | 20 | dB |

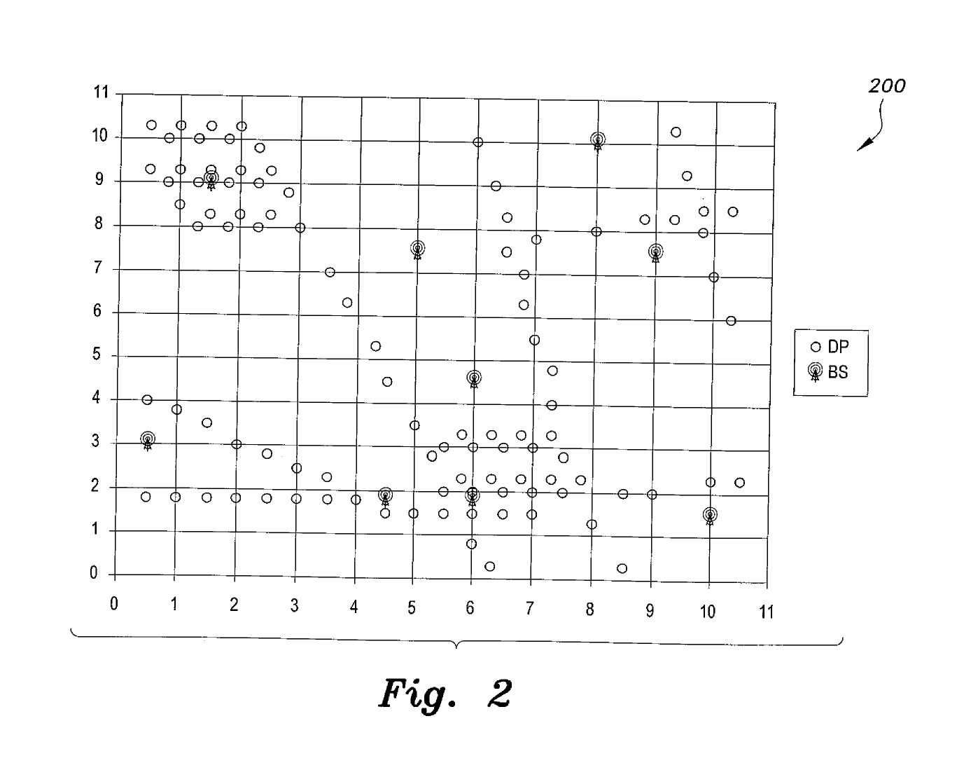

The IP for base station location and configuration problems is solved using an optimization modeling software, LINGO 12, furnished by UNDO Systems Inc. The optimal solution resulted in 9 base stations, as shown in FIG. 2. The location and configuration of each selected base station are shown in Table 4.

TABLE 4
Base Station Locations and Configuration

| | X Coor- | Y Coor- | | | | |
|---|---|---|---|---|---|---|
| BS # | dinate | dinate | Azimuth | Antenna | Height | Power |
| 1 | 0.5 | 3 | 1 | 1 | 2 | 1 |
| | | | | 2 | 2 | 1 |
| 2 | 1.5 | 9 | 1 | 1 | 2 | 1 |
| | | | | 2 | 2 | 1 |
| | | | | 3 | 2 | 1 |
| 3 | 4.5 | 2 | 2 | 1 | 2 | 1 |
| | | | | 2 | 2 | 1 |
| 4 | 5 | 7.5 | 2 | 1 | 2 | 1 |
| | | | | 2 | 2 | 1 |
| 5 | 6 | 2 | 2 | 1 | 2 | 1 |
| 6 | 6 | 4.5 | 1 | 1 | 2 | 1 |
| | | | | 2 | 2 | 1 |
| | | | | 3 | 2 | 1 |
| 7 | 8 | 10 | 2 | 1 | 2 | 1 |
| | | | | 2 | 2 | 1 |
| 8 | 9 | 7.5 | 1 | 1 | 1 | 1 |
| | | | | 2 | 2 | 1 |
| 9 | 10 | 1.5 | 2 | 2 | 2 | 1 |
| | | | | 3 | 1 | 1 |

As observed from the results above, this IP model recommends 9 base stations to cover all the demand points, even though the capacity of each base station is 30 channels. However, we should note that most of the base stations have either one antenna or two. The average number of antennas is less than two per base station. This number of recommended base stations resulted because of the low height and transmitted power of the transmitter, which are considered to satisfy the quality of service (i.e., SINR) constraint. As expected, incorporating the configuration of base stations into the model adds more flexibility to the model, resulting in all the demand points with a fewer number of base stations than if the configuration had not been considered. Moreover, the recommendation shows that different configurations are assigned to different base stations to reduce the interference between them, and also, not all sectors at each base station are working. It should be noted that the minimum number of base stations and their location could change if more candidate sites are included.

It is to be understood that the present invention is not limited to the embodiments described above, but encompasses any and all embodiments within the scope of the following claims.

We claim:

1. A computer-implemented method of optimizing location and configuration of cellular base stations, comprising the steps of:
inputting a plurality of known demand points and candidate base station sites;
inputting cellular radio signal propagation data relating to the demand points and the candidate base station sites;
inputting a plurality of directional antennas for each of the candidate base station sites;
solving an integer program based on the known demand points, the candidate base station sites, the plurality of directional antennas, and the cellular radio signal propagation data, the integer program solution being characterized by the following relation:
$$Minimize {\sum }_{j = 1}^{n} {C}_{j} {Y}_{j} + {\sum }_{j ∈ S ( i )} {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {W}_{jlATHP} CP ( P ) ,$$
subject to the constraints:
$${\sum }_{A = 0}^{359} {\sum }_{T = - 15}^{0} {\sum }_{H = {H}_{min}}^{{H}_{max}} {\sum }_{P = {P}_{min}}^{{P}_{max}} {W}_{jlATHP} \leq {Y}_{j} , \\ {W}_{jlATHP} \leq {Z}_{jA}$$
$${\sum }_{A = 0}^{359} {Z}_{jA} \leq 1$$
$${\sum }_{j ∈ S ( i )} {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {X}_{ijlATHP} = 1 , \\ {W}_{jlATHP} \geq {X}_{ijlATHP}$$
$${\sum }_{i = 1}^{n} {\sum }_{A = 0}^{359} {\sum }_{T = - 15}^{0} {\sum }_{H = {H}_{min}}^{{H}_{max}} {\sum }_{P = {P}_{min}}^{{P}_{max}} {X}_{ijlATHP} \leq Q , \\ \frac{SP ( i )}{{P}_{{N}_{i}} + TP ( i ) - SP ( i )} \geq {10}^{\frac{SINR}{10}} , \\ and X , Y , W , Z ∈ [ 0 , 1 ] ,$$
where Cⱼ is the cost of installing a base station at the j^{th} candidate site, CP(P) is the cost of having an antenna with power P, Yⱼ is the number of base stations serving the j^{th} demand point, X_{ijlATHP} is the j^{th} demand point assigned to the i^{th} base station using the l^{th} antenna, at the A^{th} azimuth angle, having the T^{th} tilt at the H^{th} height, transmitting with the P^{th} power, Q is the channel capacity of each base station, SP(i) is the strongest power received at demand point DPᵢ, TP(i) is the total power received at DPᵢ, the total power being generated by all base stations at candidate sites that can serve DPᵢ, P_{N}_{ᵢ} is the noise power at DPᵢ, and SINR is the minimum signal-to-interference-plus-noise ratio, the minimization selecting the best candidate base station sites; and
displaying a plot showing the best candidate base station sites in relation to the plurality of known demand points.

2. The computer-implemented method of optimizing location and configuration of cellular base stations according to claim 1, further comprising the step of running a COST-Walfisch-Ikegami radio propagation model to obtain said cellular radio signal propagation data.

3. A computer software product, comprising a non-transitory medium readable by a processor, the non-transitory medium having stored thereon a set of instructions for performing a method of optimizing location and configuration of cellular base stations, the set of instructions including:
(a) a first sequence of instructions which, when executed by the processor, causes said processor to input a plurality of known demand points and candidate base station sites;
(b) a second sequence of instructions which, when executed by the processor, causes said processor to input cellular radio signal propagation data relating to the demand points and the candidate base station sites;
(c) a third sequence of instructions which, when executed by the processor, causes said processor to input a plurality of directional antennas for each of said candidate base station sites;
(d) a fourth sequence of instructions which, when executed by the processor, causes said processor to solve an integer program based on said known demand points, said candidate base station sites, and said cellular radio signal propagation data, said integer program solution being characterized by the following relations,
$$Minimize {\sum }_{j = 1}^{n} {C}_{j} {Y}_{j} + {\sum }_{j ∈ S ( i )} {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {W}_{jlATHP} CP ( P )$$
Subject to:
$${\sum }_{A = 0}^{359} {\sum }_{T = - 15}^{0} {\sum }_{H = {H}_{min}}^{{H}_{max}} {\sum }_{P = {P}_{min}}^{{P}_{max}} {W}_{jlATHP} \leq {Y}_{j} , \\ {W}_{jlATHP} \leq {Z}_{jA}$$
$${\sum }_{A = 0}^{359} {Z}_{jA} \leq 1$$
$${\sum }_{j ∈ S ( i )} {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {W}_{jlATHP} \geq 1 , \\ {\sum }_{j ∈ S ( i )} {\sum }_{l = 1}^{3} {\sum }_{A = 0}^{360} {\sum }_{T = - 15}^{0} {\sum }_{H = {H}_{min}}^{{H}_{max}} {\sum }_{P = {P}_{min}}^{{P}_{max}} {X}_{ijlATHP} = 1 , \\ {W}_{jlATHP} \geq {X}_{ijlATHP} , \\ {\sum }_{i = 1}^{n} {\sum }_{A = 0}^{359} {\sum }_{T = - 15}^{0} {\sum }_{H = {H}_{min}}^{{H}_{max}} {\sum }_{P = {P}_{min}}^{{P}_{max}} {X}_{ijlATHP} \leq Q , \\ \frac{SP ( i )}{{P}_{{N}_{i}} + TP ( i ) - SP ( i )} \geq {10}^{\frac{SINR}{10}} , \\ and X , Y , W , Z ∈ [ 0 , 1 ] ,$$
where, Cⱼ is the cost of installing a base station at the j^{th} candidate site, CP(P) is the cost of having an antenna with power P, Yⱼ is the number of base stations serving the j^{th} demand point, X_{ijlATHP} is the j^{th} demand point assigned to the i^{th} base station using the l^{th} antenna, at the A^{th} azimuth angle, having the T^{th} tilt at the H^{th} height, transmitting with the P^{th} power, Q is the channel capacity of each base station, SP (i) is the strongest power received at demand point DPᵢ, TP(i) is the total power received at DPᵢ, the total power being generated by all base stations at candidate sites that can serve DPᵢ, P_{N}_{ᵢ} is the noise power at DPᵢ, and SINR is the minimum signal-to-interference-plus-noise ratio, the minimization selecting the best candidate base station sites; and
(e) a fifth sequence of instructions which, when executed by the processor, causes said processor to display a plot showing the best candidate base station sites in relation to the plurality of known demand points.

4. The computer software product according to claim 3, further comprising a sixth sequence of instructions which, when executed by the processor, causes said processor to run a COST-Walfisch-Ikegami radio propagation model to obtain said cellular radio signal propagation data.
